(19) United States
(12) Patent Application Publication
(10) Pub. No.: US 2002/0098791 A1
(43) Pub. Date: Jul. 25, 2002

(54) Methods and apparatus for processing pork belly slabs

(75) Inventors: Gary A. Handel, Austin, MN (US); Jeffrey J. Morrison, Austin, MN (US)

Correspondence Address: Mau & Krull, P.A., Suite E, 1250 Moore Lake Drive East, Fridley, MN, 55432, US

(73) Assignee: Hormel Foods, LLC

(21) Appl. No.: 09/770,013

(22) Filed: Jan. 25, 2001

(51) Int. Cl. A22C 25/14; A22C 25/18; A22C 25/20

(52) U.S. Cl. 452/150

(57) ABSTRACT

Pork belly slabs are arranged into a vertical stack and loaded into a magazine. The lowermost slab is push through a gate on the magazine and then held in place until engaged by a gripper. The gripper pushes the slab into a bacon slicing unit, and then a left over end of the slab is ejected into a receptacle before the process is repeated.

### FIELD OF THE INVENTION

The present invention relates generally to methods and apparatus for automated handling and processing of material, and is particularly well suited for converting pork bellies into slices of bacon.

### BACKGROUND OF THE INVENTION

In many situations, it is well recognized that time is indeed money, and greater efficiency translates into greater profit. This adage holds true in the food processing industry, where sophisticated and expensive machinery is used to process food in bulk quantities. Generally speaking, costs can be minimized by maximizing the use and productivity of such machinery.

In the bacon industry, for example, machines have been developed to cut pork bellies into strips of bacon. According to one known process, a trailing end of a pork belly slab is grabbed by a feed member, and the leading end of the pork belly slab is pushed into engagement with a slicer. An example of such equipment is the Weber 501 made by Weber, Inc., Kansas City, Mo.

An object of the present invention is to keep the cutting machinery in operation as much as possible. Another object of the present invention is to minimize manual labor associated with operation of the cutting machinery.

### SUMMARY OF THE INVENTION

One aspect of the present invention is to provide a cutting machine in combination with a magazine that is designed to hold a plurality of slabs in a vertical array or stack. In cooperation with gravitational force, the magazine periodically dispenses the lowermost slab in the stack. As the slabs in the magazine are depleted, additional slabs may be added to the top of the stack without interrupting the dispensing process. This arrangement may be considered advantageous to the extent that a slab is always ready to be processed by the cutting machine; and/or no handling of individual slabs is required.

Another aspect of the present invention is to provide a cutting machine in combination with a magazine that is designed to hold a plurality of slabs above the cutting machine. In cooperation with gravitational force, the magazine periodically dispenses the slab nearest the slicer bed of the cutting machine. As the slabs in the magazine are depleted, additional slabs may be added without interrupting the dispensing process. This arrangement may be considered advantageous to the extent that additional floor space is not required to accommodate the magazine; and/or relatively little handling and/or maneuvering of the slabs is required.

A preferred embodiment of the present invention incorporates both of the aspects discussed above. Many of the features and/or advantages of the present invention will become apparent from the more detailed description that follows.

### BRIEF DESCRIPTION OF THE FIGURES OF THE DRAWING

With reference to the Figures of the Drawing, wherein like numerals represent like parts and assemblies throughout the several views,

FIG. 1 is a front view of a preferred embodiment pork belly processing system constructed according to the principles of the present invention;

FIG. 2 is an exploded perspective view of the dispensing portion of the system of FIG. 1;

FIG. 3a is a perspective view of a pork belly magazine constructed according to the principles of the present invention, and shown holding a stack of pork bellies;

FIG. 3b is a perspective view of the pork belly magazine of FIG. 3a, shown dispensing the lowermost pork belly in the stack; and

FIGS. 4a-4i are diagrammatic views of the system of FIG. 1 at various stages in a preferred mode of operation.

### DETAILED DESCRIPTION OF A PREFERRED EMBODIMENT

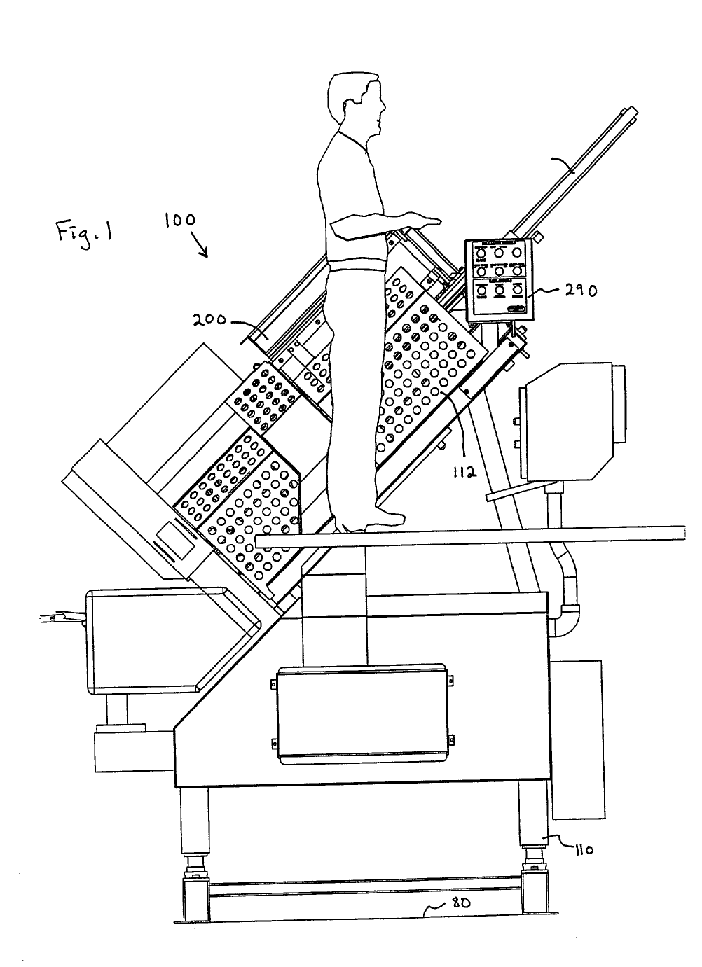

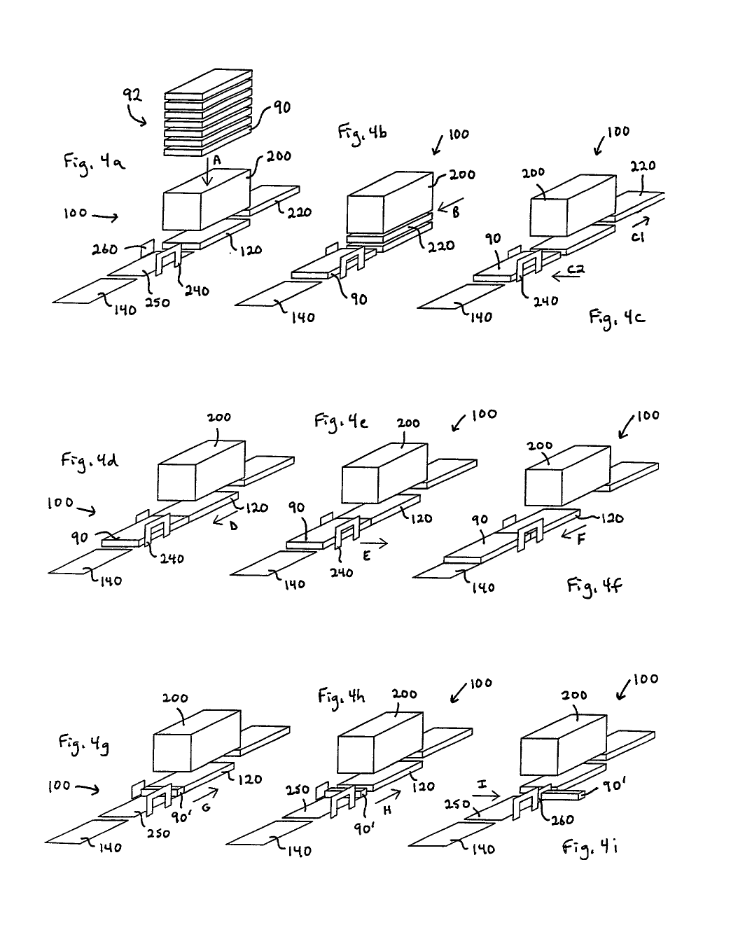

A preferred embodiment processing system constructed according to the principles of the present invention is designated as 100 in FIGS. 1 and 4a-4i. Generally speaking, the system 100 includes a frame 110 configured to rest upon a horizontal floor surface 80, a bacon slicing unit mounted on the frame 110, and a pork belly loading unit mounted on the frame 110 and above the slicing unit. The slicing unit operates in a manner already known in the art and therefore, is not described herein in detail. The slicing unit may be any suitable slicing unit such as the Weber 501 or the unit described in U.S. Pat. No. 5,481,466 entitled “Meat Slicing Machine and Method of Use Thereof”, which is hereby incorporated by reference. Shrouding 112 is mounted on the frame 110 and configured to cover the moving parts of both the slicing unit and the loading unit. Portions of the shrouding are hinged relative to one another to facilitate access to the interior components of the system 100.

FIGS. 4a-4i show diagrammatic representations of the main components of the system 100 during various stages of operation. These components operate in response to control signals which may be generated manually and/or by an automated program. For example, a control panel is designated as 290 in FIG. 1.

As shown in FIG. 4a, pork belly slabs 90 are arranged in a vertical stack 92 and loaded into a magazine assembly 200 (as suggested by arrow A). In response to a start signal, a pusher assembly 220 pushes the lowermost slab 90 in the stack out of the magazine assembly 200 and onto a receiving surface 250 (as suggested by arrow B in FIG. 4b), and then the pusher assembly 220 returns to its ready position (as suggested by arrow C1 in FIG. 4c). Also shown in FIG. 4c, a stabilizer assembly 240 moves in the direction of arrow C2 to hold the slab 90 steady and/or positively position the slab 90. As suggested by the arrow D in FIG. 4d, a gripper assembly 120 moves toward and clamps onto the trailing end of the slab 90. The stabilizer assembly 240 then releases the slab 90 (as suggested by the arrow E in FIG. 4e), and thereafter, the gripper assembly 120 pushes the leading edge of the slab 90 through the entrance of a conventional bacon slicing assembly 140 (as suggested by the arrow F in FIG. 4f). After a desired number of bacon slices have been cut from the slab 90, the gripper assembly 120 pulls the remaining, “butt end” 90′ back toward the magazine assembly 200 (as suggested by the arrow G in FIG. 4g). The gripper assembly 120 then releases the butt end 90′ and withdraws to its ready position (as suggested by the arrow H in FIG. 4h). An ejector assembly 260 then moves as suggested by the arrow I in FIG. 4i to eject the butt end 90′ from the receiving surface 250 and into a collection bin (not shown), thereby making room for the next slab to be dispensed from the magazine assembly 200. After the ejector assembly 260 returns to its ready position (shown in FIG. 4a), the process begins again with the step shown in FIG. 4b. As the stack of slabs 90 in the magazine 200 assembly dwindles, additional slabs may be added without interrupting the process.

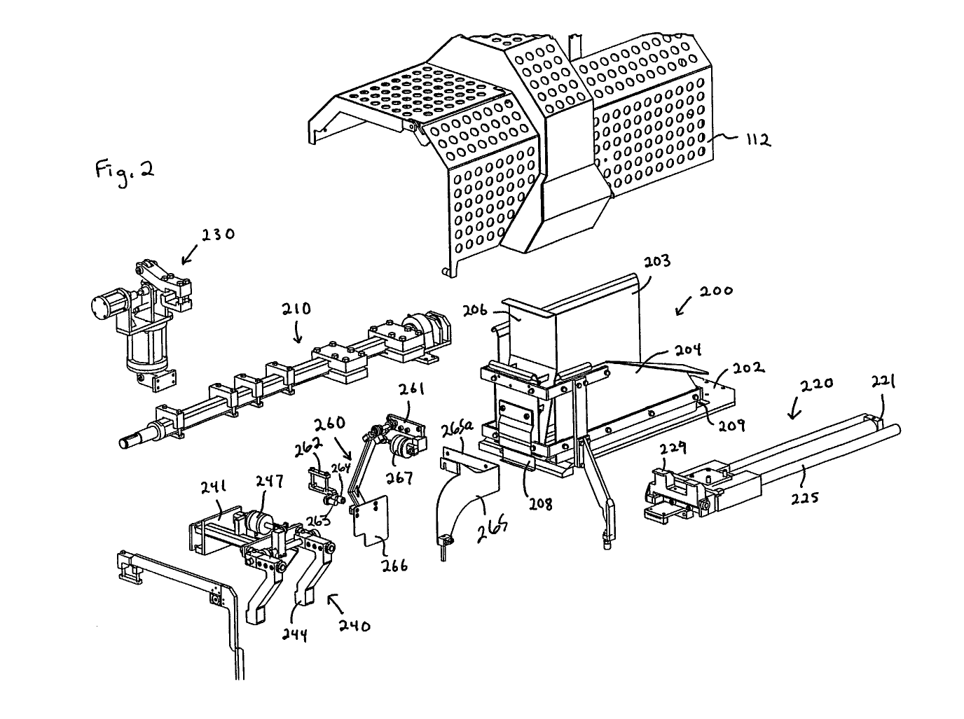

The main components of the loading unit are shown in greater detail in FIG. 2. A mount shaft or chassis 210 is rotatably mounted on the frame 110 and supports the other components of the loading unit. A counter-balance assembly 230 is mounted on the mount shaft 210 and facilitates upward pivoting of the loading unit about the longitudinal axis of the mount shaft 210, and relative to the slicing unit.

The magazine assembly 200 defines a generally box-shaped container bounded by a bottom wall 202, opposite side walls 203 and 204 and a front wall 206. The preferred embodiment container is sized and configured to hold a vertical stack of ten pork belly slabs. Relative to a line extending perpendicularly through the pork belly slabs, the front wall 206 angles downwardly and forwardly to a distal end which is upwardly spaced from the bottom wall 202, thereby defining an opening. A gate 208 extends across at least a portion of the opening to discourage unintended departure of a pork belly slab 90 from the container. On the assembly 200, the gate 208 is a metal leaf spring.

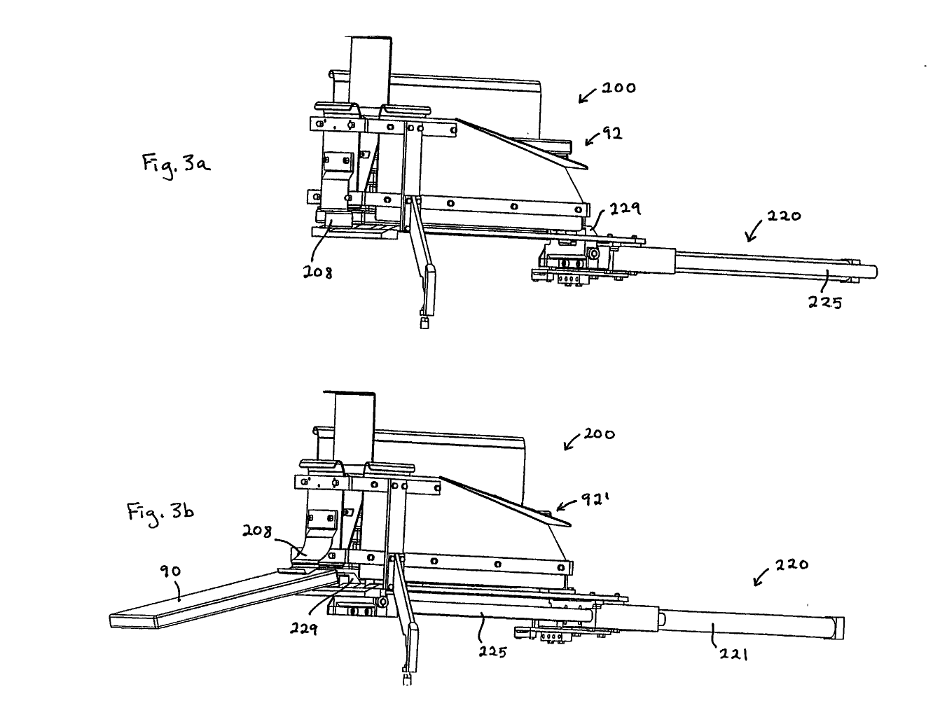

The pusher assembly 220 includes a base 221, first and second actuators or push rods 225, and first and second pawls or pushers 229. The pawls 229 are preferably rotatable relative to the push rods 225, and are sized and configured to enter respective slots 209 in the bottom wall 202 of the magazine assembly 200. FIGS. 3a and 3b show the magazine assembly 200 and the pusher assembly 220 in relation to one another, as well as a stack 92 of pork belly slabs 90. FIG. 3a shows the pusher assembly 220 in its “ready” position, with the pusher rods 225 retracted, and the pawls 229 protruding upward through the bottom wall 202 of the magazine assembly 200. FIG. 3b shows the pusher assembly 220 in its “delivered” position, with the pusher rods 225 fully extended, and the pork belly slab 90 exiting the magazine assembly 200 (thereby leaving a relatively smaller stack 92′). As suggested by the foregoing, the pusher rods 225 exert sufficient force to deflect the gate 208, and the pusher assembly 220 may be described as a means for delivering or dispensing pork belly slabs from the magazine assembly 200.

The pawls 229 pivot forward and downward to facilitate a smooth return of the pusher assembly 220 to its ready position. On the preferred embodiment 100, the weight of the pork belly slabs in the stack 92′ cooperates with the rearward movement of the pusher rods 225 to pivot the pawls 229 forward and downward during the return stroke. The pawls are returned to an upright position by a cam action, and are retained in an upright position using spring-loaded shaft detents. Also, a rear wall is preferably provided on the magazine assembly 200 to ensure that the pork belly slabs 90 do not travel rearward together with the pawls 229.

With reference back to FIG. 2, the stabilizer assembly 240 generally includes a base 241 mounted on the mount shaft 210, first and second arms 244 movably mounted on the base 241, and an actuator or motor 247 interconnected between the arms 244 and the base 241 and operable to move the former relative to the latter. As described above with reference to FIGS. 4a-4i, the arms 244 temporarily push a pork belly slab 90 against an opposing stop or support (not shown) to clamp the slab 90 in place. In this regard, the stabilizer assembly 240 may also be described as a means for positively positioning a pork belly slab to facilitate proper engagement by the gripper assembly 120 of the conventional slicing unit.

The ejector assembly 260 generally includes a base 261 mounted on the frame of magazine assembly 200, a plate movably mounted on the base 261, and an actuator or motor 267 interconnected between the plate 266 and the base 261 and operable to move the former relative to the latter. As described above with reference to FIGS. 4a-4i, the plate 266 ejects the “butt end” portion of a pork belly slab 90 after a desired number of bacon slices have been cut from the slab 90. In other words, the ejector assembly 260 may be described as a means for ejecting a remnant of the pork belly slab. A holder assembly 262 supports a proximity sensor 263 and a rubber bumper 264. The proximity sensor 263 is used to sense the position of the ejector assembly 260, and thereby can control the appropriate time for allowing another pork belly slab 90 to be dispensed. That is, after the ejector assembly 260 has ejected, the “butt end” of the pork belly slab 90, it goes back to a home position where the proximity sensor 263 then will know that it is in a position to initiate the loading of another pork belly slab. The rubber bumper 264 is simply used as a stop as the ejector assembly 260 returns to its home position after ejecting a pork belly slab 90. A pork belly guide 265 has a top support member 265a which is positioned at a spaced distance and slightly below the gate 208 to assist in guiding the pork belly slabs 90 as they are dispensed.

An advantage of the present invention is that it is designed for use with existing bacon slicing equipment. Among other things, the magazine assembly 200 is mounted above the gripper assembly 120, and the slabs 90 are delivered to a receiving area 250 that already exists between the gripper assembly 120 and the slicing assembly 140. In other words, the preferred embodiment of the present invention delivers pork belly slabs 90 “in line” between the gripper assembly 120 and the slicing assembly 140 on an existing bacon slicing machine. Also, the present invention reduces both the potential for injuries (by eliminating handling steps) and the costly “down time” of the existing slicing equipment (by facilitating uninterrupted operation). Yet another advantage of the present invention is that the loading unit does not require separate floor space and/or a separate floor engaging frame.

The foregoing description and accompanying figures disclose a preferred embodiment and particular application of the present invention. However, those skilled in the art are likely to recognize additional embodiments, applications, and/or variations which nonetheless incorporate the essence of the present invention. Accordingly, the scope of the present invention is to be limited only to the extent of the following claims.

What is claimed is:

1. A method of converting pork belly slabs into strips of bacon, comprising the steps of:
providing a bacon cutting machine having an entrance;
providing a magazine configured to hold a plurality of pork belly slabs in a vertical stack;
securing the magazine and the cutting machine relative to one another in such a manner that a lower end of the magazine is generally aligned with the entrance of the cutting machine;
loading a vertical stack of pork belly slabs into the magazine; and
intermittently delivering a lowermost one of the pork belly slabs to the entrance of the cutting machine.

2. The method of claim 1, wherein the delivering step involves pushing the lowermost one of the pork belly slabs through a leaf spring gate on the magazine.

3. The method of claim 2, wherein the delivering step subsequently involves positively positioning the lowermost one of the pork belly slabs for engagement by a feed member.

4. The method of claim 3, further comprising the subsequent step of ejecting a remnant of the lowermost one of the pork belly slabs to a receptacle.

5. The method of claim 1, wherein the delivering step involves inserting a pushing member upward into the magazine and rearward of the lowermost one of the pork belly slabs.

6. A method of converting pork belly slabs into strips of bacon, comprising the steps of:
providing a bacon cutting machine having an entrance;
providing a magazine configured to hold a stack of pork belly slabs;
mounting the magazine above the cutting machine;
loading a stack of pork belly slabs into the magazine; and
intermittently delivering a lowermost one of the pork belly slabs downward to the entrance of the cutting machine.

7. The method of claim 6, wherein the delivering step involves pushing the lowermost one of the pork belly slabs through a leaf spring gate on the magazine.

8. The method of claim 7, wherein the delivering step subsequently involves positively positioning the lowermost one of the pork belly slabs for engagement by a feed member.

9. The method of claim 8, further comprising the subsequent step of ejecting a remnant of the lowermost one of the pork belly slabs to a receptacle.

10. The method of claim 6, wherein the delivering step involves inserting a pushing member upward into the magazine and rearward of the lowermost one of the pork belly slabs.

11. A pork belly processing system, comprising:
a bacon cutting machine having an entrance;
a magazine configured to hold a stack of pork belly slabs; and
a delivering means for delivering a lowermost one of the pork belly slabs from the magazine to the bacon cutting machine, wherein the delivering means includes a positioning means for positively positioning the lowermost one of the pork belly slabs relative to the bacon cutting machine.

12. The system of claim 11, further comprising an ejecting means for ejecting a remnant of the lowermost one of the pork belly slabs into a receptacle.

13. The system of claim 11, wherein the delivering means includes a pushing member which is movable into a ready position, inside the magazine and directly behind the lowermost one of the pork belly slabs.

14. The system of claim 13, wherein the magazine includes a leaf spring gate disposed directly in front of the lowermost one of the pork belly slabs.

15. The system of claim 11, wherein the positioning means includes a clamp disposed between the magazine and the entrance of the bacon-cutting machine.

16. A pork belly processing system, comprising:
a bacon cutting machine having an entrance;
a magazine configured to hold a stack of pork belly slabs, wherein the magazine includes a front wall having an opening that is configured and arranged to accommodate passage of only a lowermost one of the pork belly slabs;
a pusher occupying a ready position directly behind the lowermost one of the pork belly slabs; and
a receiving area disposed between the opening and the entrance of the bacon cutting machine.

17. The system of claim 16, wherein the pusher is selectively movable toward the opening and rotates to a retracted position during movement away from the opening.

18. The system of claim 16, wherein a leaf spring gate extends across at least a portion of the opening.

19. The system of claim 16, wherein relative to a line extending perpendicularly through the pork belly slabs, the front wall angles downward and forward toward the opening.

20. The system of claim 16, further comprising a clamp occupying a ready position proximate the receiving area.
